(19) United States
(12) Patent Application Publication
(10) Pub. No.: US 2008/0155530 A1
(43) Pub. Date: Jun. 26, 2008

(54) Method For Displaying Text Messages, Terminal and Program For Implementing Said Method

(75) Inventors: Denis Prouvost, Paris (FR); Jean-Noel Stehly, Issy Les Moulineaux (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/883,797

(22) PCT Filed: Feb. 6, 2006
(86) PCT No.: PCT/FR2006/000269

§ 371 Date: Aug. 7, 2007

(30) Foreign Application Priority Data
Feb. 7, 2005 (FR) 0501199

(51) Int. Cl. G06F 9/445

(52) U.S. Cl. 717/174

(57) ABSTRACT

Disclosed is a system and method for customizing the display of text messages received by a communications terminal, such as a cell phone. The method includes downloading and installing at least one display module that controls animated rendering of a received text message with a predefined animation; recording at least one display module selection criterion, which corresponds to the installed module; analyzing characteristics of a received text message to be displayed; selecting a display module when a selection criterion associated with the display module is fulfilled by the analyzed characteristics; and submitting the received text message to the selected display module.

The present invention relates to the displaying of text messages received on telecommunication terminals.

Messaging in text form is widely used in cellular radiocommunication networks. The short message service (SMS) has been developed to allow the display on mobile telephones of text messages transmitted to the user (SMS-MT) or broadcast (SMS-CB). The displaying of an SMS received is very similar on all mobile telephones. The text of the SMS received is simply displayed on the screen of the telephone without the user being able to modify the way in which it is displayed.

There exist various classes of SMS. Class 0 messages are displayed directly on the screen; those of class 1 are displayed only following an action of the user after receipt.

Certain mobile terminals can connect to the Internet and receive electronic messages (email). Here again, the displaying of a message received is very similar on all mobile telephones, as moreover on computers or other terminals linked up by a wire interface: the terminal simply displays the text of the message received.

U.S. Pat. No. 5,765,178 describes an electronic messaging system in which the user can adjust certain parameters of the text processing program serving to present the message on his computer, for example the font, the size, the color or the case of the characters or the line spacing of all or some of the text to be displayed. This adjustment varies as a function of characteristics of the incoming messages such as the identity of the sender, the subject or the priority of the message. This system remains limited to text formatting attributes, thereby offering only few customization possibilities. In particular, it does not make it possible to supplement the display of the messages with multimedia components: sounds, images, animations, etc. Moreover, the differentiation of the display format requires that the terminal be equipped with software of text processing type, this not being the case with a certain number of terminals, in particular most mobile telephones.

The standardized cellular networks have been enhanced by a multimedia messaging service (MMS). By definition, an MMS message comprises its own description of the display mode, which is specified by the sender of the message. The recipient furnished with an MMS compatible terminal, has no choice over the manner in which the message be will displayed.

An aim of the present invention is to widen the possibilities for customizing display of text messages received on terminals, in particular mobile terminals, so as to render messaging services more attractive. Another aim is to introduce a multimedia component into the display of messages transmitted in simple text mode.

The invention thus proposes a method of displaying text messages received by a communication terminal, comprising the following steps:
installing in the terminal at least one display module, each display module controlling animated rendering of a text message with a predefined animation;
recording at least one display module selection criterion and associating each recorded criterion with a display module installed in the terminal;
analyzing characteristics of a text message to be displayed, selecting a display module installed in the terminal when a selection criterion associated with said display module is fulfilled by the analyzed characteristics, and submitting said text message to the selected display module.

A display module selection criterion is understood to be a set of rules that the characteristics of a message received must comply with so that the latter is displayed by a given module.

The method improves the visual look when reading the messages received, for example SMSs on a mobile telephone.

It also allows the operator and/or the user client to modify and customize a posteriori this visual look. The customization does not result from an adjustment of local parameters (for example characters in bold, red color, etc.), which is a relatively laborious operation on a terminal of small size such as a mobile telephone. Moreover, such an operation requires that the terminal has available editing software presenting choices of text processing parameters, this generally not being the case. On the contrary, according to the invention, rendering of the text messages by the display modules is animated, and the animation is predefined.

The user can visualize the display modules so as to choose the one which suits him and decide to associate it with such and such a criterion.

In an advantageous embodiment, the step of installing a display module comprises a downloading of this module from a server. The invention also relates to a server for downloading display modules for the execution of such a method. The server comprises a network interface for access from user terminals, and a set of display modules downloadable from the user terminals, the execution of each display module controlling animated rendering of a text message with a predefined animation.

Such a server hosts a new service, which improves the attractiveness of a service of SMS type. It offers users the possibility of customizing their terminals by profiting from the creativity of various animation designers.

The criteria for selecting recorded display modules can pertain to text message characteristics including in particular the type of message, a class of the message, the size of the message, the instant of sending and/or of reception of the message, the identity of the sender of the message, an importance level of the message, the number and/or the identities of other recipients of the message.

Another aspect of the invention pertains to a communication terminal comprising means for displaying text messages received. These display means comprise:
at least one display module for controlling animated rendering of a text message with a predefined animation;
a database for recording at least one display module selection criterion associated with a display module; and
means for analyzing characteristics of a text message to be displayed, so as to select a display module when a selection criterion associated with said display module is fulfilled by the analyzed characteristics and submit said text message to the selected display module.

Still another aspect of the invention pertains to a computer program to be installed in a communication terminal so as to control the display of text messages during an execution of the program by a processing unit of the terminal. This program comprises:
at least one display module whose execution controls animated rendering of a text message with a predefined animation;
instructions for examining, in relation to characteristics of a text message to be displayed, at least one display module selection criterion recorded in the terminal in association with a display module so as to select a display module when a selection criterion associated with said display module is fulfilled by the analyzed characteristics and to execute the display module selected for said text message.

Other features and advantages of the present invention will appear in the description hereinafter of nonlimiting exemplary embodiments, with reference to the appended drawings, in which:

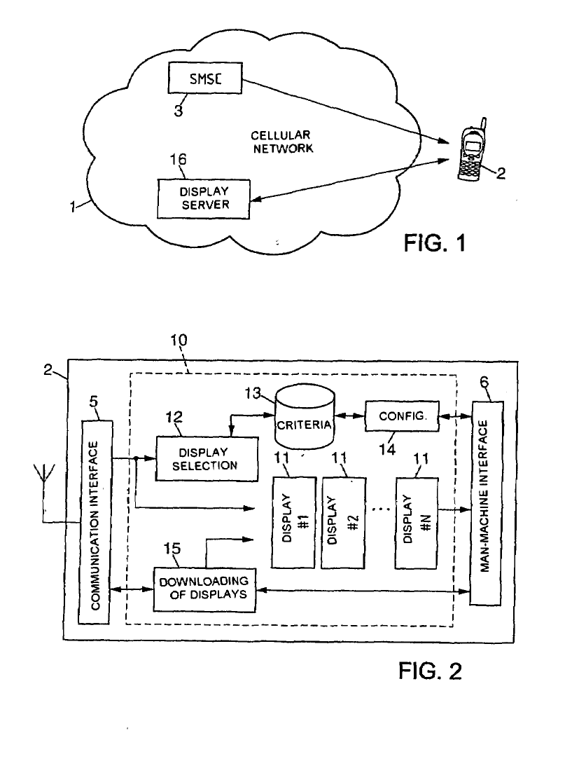

FIG. 1 is a diagram of a cellular system supporting a method according to the invention;

FIG. 2 is a schematic diagram of a terminal according to the invention, of mobile telephone type; and

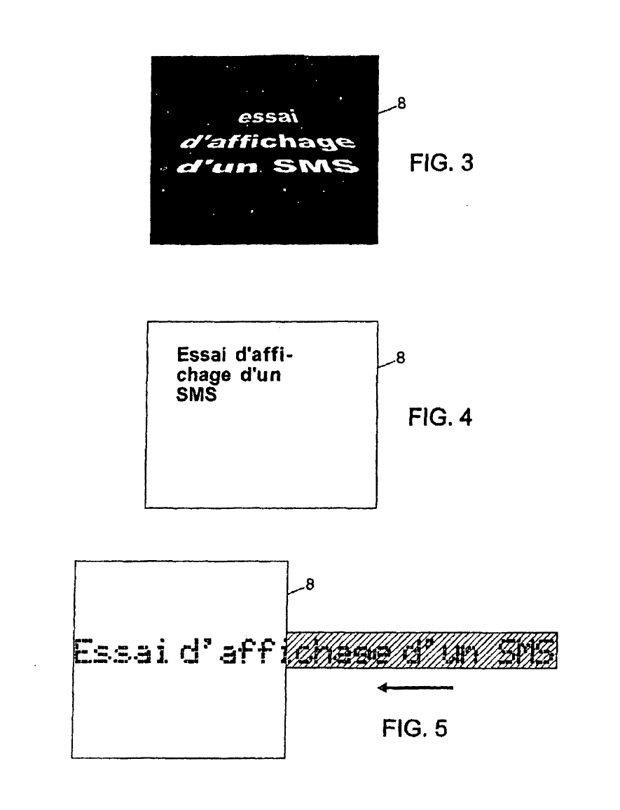

FIGS. 3 to 5 are illustrations of animated displays of text messages produced by display modules and usable in embodiments of the invention.

The invention is described hereinafter in its particular, nonlimiting, application to the short message service (SMS) implemented in a cellular radiocommunication system of GSM or analogous type. If the relevant GSM terminal has the tools necessary for receiving electronic messages (emails), the method is readily extended to the display of this type of message also.

FIG. 1 schematically illustrates the cellular network 1 of an operator, deployed over a coverage territory. This network allows mobile terminals 2 to communicate over the coverage territory. The various entities of the GSM network are described in detail in standardization documents and are well known in the art of cellular radio.

One of these entities is an SMS service center 3 (SMSC, “Short Message Service Center”), where the text messages intended for the subscribers of the operator are received, stored if necessary and transmitted to the terminals of these subscribers. The invention makes it possible to enhance the mode of displaying the SMS messages, by enriching the presentation of the text with visual and/or sound effects. FIG. 2 illustrates an example of means usable in the mobile terminal 2 for affording this enhancement.

The terminal 2 comprises in a conventional manner an interface 5 for communication with the cellular network 1. This interface 5 implements the GSM radio communication procedures, and incorporates the various protocols, in particular those useful for sending and receiving SMSs. The terminal also has a man-machine interface (MMI) 6 which comprises in a conventional manner a display screen, a loudspeaker, a microphone, a keyboard and associated electronic control circuits.

According to the invention, the terminal 2 is equipped with a display manager 10 for processing the SMS messages or emails received and for controlling their display by means of the MMI 6. The display will generally be of multimedia type, with visual animations for presenting the text of the message on the screen of the terminal and/or sound effects played back by the loudspeaker.

The display manager 10 typically consists of a computer program installed in the terminal during its manufacture, or loaded remotely into the latter. The program 10 is executed by a processor (not represented) with which the terminal is provided.

The display manager 10 comprises one or more display modules 11, simply called “displays” hereinafter. A message display 11 is in charge of the display of a message according to a defined scenario. It involves a computer program which contains the whole process for displaying the message (visual effects, sound, etc.). When a display 11 is activated, it is executed by taking into account the message characteristics which it requires (the content of the message but also its date of dispatch, the identity of the sender of the message, etc.).

The user has no possibility of modifying the display characteristics of a display. He will have to install new displays 11 on his terminal 2 if he wishes to change the modalities for displaying his messages.

By way of illustration, FIGS. 3 to 5 show examples of displaying, on the screen 8 of the terminal, a message whose text is “essai d'affichage d'un SMS” by means of three distinct displays 11.

FIG. 3 corresponds to a “Star Wars” (trademark) display. When a message received is displayed by this display, the text scrolls in perspective from the foreground to the vanishing point. Stars accompany the scrolling of the text on the screen 8. Characteristic music can accompany this display.

FIG. 4 corresponds to a “Typewriter” display. When a message received is displayed by this display, the text is displayed character by character on a background image representing a sheet of paper, as if it were being typed by a typewriter. During each display of a new character of the message received, the noise characteristic of the typing of a character by a typewriter is emitted.

FIG. 5 corresponds to a display of “Commercial” type. When a message received is displayed by this display, the text scrolls horizontally on the screen 8, in a character style imitating the displays having small red bulbs (LEDs).

The possibilities of creating such message animations, that is to say different displays 11, are very extensive.

The display manager 10 comprises a display selector 12 which intercepts all the text messages received by the terminal 2. The selector 12 analyzes the characteristics of each message to be displayed, either during receipt of the message, or during its recall from a memory where the terminal 2 may possibly have recorded it.

The characteristics of the messages which are analyzed by the selector can be chosen from among the following:
Message type (SMS, email, etc.);
Class of message (class 0, class 1, etc.);
Size of message;
Date and time or time span, day of the week when sent;
Date and time or time span, day of the week of receipt;
Identifier (address, telephone number, name, etc.) of the sender of the message;
Importance level of the recipient of the message (for example, for an email, if the recipient is main recipient of the message or only copied with it);
Number and identifier of the other recipients of the message;
etc.

These various characteristics are in general described in header fields of the incoming message, thereby allowing the selector 12 to appraise them. The analysis of these characteristics of the messages is performed by the selector 12 in relation to one or more display selection criteria stored in a database 13 of the terminal, which can be internal or external to the program 10.

A display selection criterion is a set of rules that the characteristics of a message received must comply with so that the latter is displayed by a given message display.

For example, the user can install a display 11 and define as criterion for selecting this display that it must be used for any message originating from a given sender. The user could also define that a given display is used for any message of a certain type received on Sunday.

The criteria can be defined once and for all during the installation of the program. But preferably, they are defined by the user by means of the MMI 6 and a configuration module 14 of the display manager 10. The configuration module 14 presents the user with choices of parameters or characteristics to which the analysis may pertain, as well as the possibility of choosing one or more values or spans of values for these parameters or characteristics. The user can thus define the criteria for selecting displays. The configuration module 14 also presents the user with the various displays 11 available in the terminal, so that the user associates a display 11 with each criterion that he has defined.

The criteria for selecting a display 11 can be modified by the user as many times as he wishes.

On receipt of a new message, the selector 12 makes a sequential search through the criteria for selecting displays which can be introduced into the base 13 with an order of priority of examination. When it encounters a criterion that is satisfied by the characteristics of the message, it selects the display 11 associated with this criterion and steers the message towards the selected display, so that it is presented with the appropriate animation.

One of the displays, for example used by default when none of the criteria defined by the user is fulfilled, can be the basic display whose terminal 2 is provided in series.

The display manager 10 preferably comprises a module 15 for downloading and installing new displays 11. This module 15 cooperates with the interfaces 5, 6 so as to allow the terminal 2 to access a display server 16 linked to the cellular network 1 and to download via the network 1 one or more programs or files corresponding to one or more displays 11. In the diagrammatic illustration of FIG. 1, the display server 16 is represented as a server of the network 1. It can also be accessible via the SMSC 3 or via the Internet across an appropriate gateway.

The downloading can be initiated by the user client, the operator or a third party commissioned by the client or the operator. The downloaded object contains at least one display 11. The latter can be associated by default with one or more selection criteria.

The module 15 is responsible for installing in the terminal the displays 11 which have been downloaded. Subsequent to the downloading and installation of a new display 11, the module 15 can run the configuration module 14 so as to allow the user to modify this display's default selection criterion or criteria which may be absent or incomplete or which do not correspond to the user's choices. The default criteria or those modified by the user via the module 14 are recorded in the list 13 in association with the installed display.

In an embodiment of the invention on a mobile telephone, the display manager 10 is embodied using “Java MIDP” (trademark) technology. In the Java MIDP (“Mobile Information Device Profile”) technology, a downloading unit is called a “MIDlet Suite” and contains one or more “MIDlets”. A “MIDlet” is a program called an “application” in the Java context. The display manager 10 according to the invention can be integrated within a MIDlet Suite containing a single MIDlet. The display selector 12, the base of selection criteria 13 and the various supported displays 11 are then implemented in the same application.

During the installation of this MIDlet Suite, the latter signals to the AMS (“Application Management Software”, which manages the installation, triggering, execution, updating and deletion of the MIDlet Suite in the terminal 2) that it must receive all the SMSs originating from the SMSC. A menu proposed to the user when he manually runs the MIDlet implements the configuration module 14 so as to allow it to create then dynamically modify the selection criteria for one of the various displays 11 as a function of the characteristics of the message received (sender of the message, date, etc.).

When an SMS message is received by the mobile telephone 2, the AMS is responsible for triggering this MIDlet which thereafter executes the Java class (part of the executable code) corresponding to the selected display 11 as a function of the characteristics of the message.

Java MIDP technology does not make it possible to update a MIDlet Suite by downloading new classes. Thus, to add one or more new displays 11 to a terminal 2 which already contains some, it is necessary to download a new MIDlet Suite which will contain all the chosen message displays (the old ones and the new ones).

In this configuration, the downloading server 16 has to preserve for each client using this service the list of displays 11 already downloaded and all the selection criteria used so as to be able to create a new MIDlet Suite containing the old displays used, the new chosen displays and the existing list of the selection criteria when the client asks to download a new display. The terminal can also communicate the list of displays 11 already present during the download request. The list of selection criteria can also be stored in the memory of the terminal. The new MIDlet Suite will replace the old one in the mobile telephone of the client.

In a next version of Java MIDP, it will be possible to run a MIDlet Suite from another MIDlet Suite, and therefore to download new displays 11 in the form of new MIDlet Suites. There would therefore be a main MIDlet Suite, which would contain the display selector 12 and the criteria for selecting the displays, and MIDlet Suites which would each constitute a different display.

In another embodiment of the invention on a mobile telephone, the display manager 10 is embodied using “Windows Smartphone 2003”, (trademark) technology. All the components 11-15 of the display manager 10 are installed in a single built-in program. During the installation of this application, a subroutine (an executable which corresponds here to the display selector 12) registers so as to be triggered by the operating system of the mobile terminal 2 with each receipt of an SMS originating from the SMSC. The latter is then responsible for selecting the appropriate display 11 to display the message. Another executable makes it possible to read the SMSs recorded in the inbox with its corresponding display. The criterion or criteria for selecting a display are stored in a database 13 of the mobile terminal.

By executing the application, the user can view all the already installed displays 11 and a menu implements the modules 14, 15 of the schematic of FIG. 2 so as to allow it to perform the following operations:
uninstall an existing display;
install a new display;
define new criteria for selecting the displays.

For a given display, it is possible to establish or to modify its selection criterion or criteria according to pre-established rules (date, time, sender of the message, etc.).

The display server 16 can then be embodied as a Web server. By selecting an option “Install a new display” from the menu of the application, the built-in program runs the browser of the terminal on an HTML page of the server 16 which contains a list of displays available for downloading on this server. Each display 11 takes the form of an executable. When a new display is chosen, it is downloaded by the browser to the telecommunication terminal then recorded in a directory which groups together all the displays already available in the application. Each display 11 contains the name of the directory in which it must be registered.

It will be understood that numerous other embodiments of the invention are possible, in varied software and hardware environments.

1. A method of displaying text messages received by a communication terminal, comprising:
installing in the communication terminal at least one display module, the at least one display module controlling animated rendering of a text message with a predefined animation;
recording at least one display module selection criterion and associating the at least one recorded display module criterion with a display module installed in the communication terminal;
analyzing characteristics of a text message to be displayed, selecting a display module installed in the communication terminal when a display module selection criterion associated with said display module is fulfilled by the analyzed characteristics, and submitting said text message to the selected display module.

2. The method as claimed in claim 1, in which the step of installing a display module comprises a downloading of said display module from a server.

3. The method as claimed in claim 1 or 2, in which the at least one display module recorded selection criterion pertains to characteristics of text messages that are included in a set of characteristics including the type of message, a class of the message, the size of the message, the instant of sending and/or of reception of the message, the identity of the sender of the message, an importance level of the message, the number and/or the identities of other recipients of the message.

4. A communication terminal having a means for displaying text messages received, the means for displaying comprising:
at least one display module for controlling animated rendering of a text message with a predefined animation;
a database for recording at least one display module selection criterion associated with a display module; and
means for analyzing characteristics of a text message to be displayed, so as to select a display module when a display module selection criterion associated with said display module is fulfilled by the analyzed characteristics and submit said text message to the selected display module.

5. The communication terminal as claimed in claim 4, further comprising means for downloading display modules from at least one server for the installation of new display modules in the communication terminal.

6. The communication terminal as claimed in claim 4 or 5, in which the recorded display module selection criteria pertain to characteristics of text messages that are included in a set of characteristics including the type of message, the size of the message, the instant of sending and/or of reception of the message, the identity of the sender of the message, an importance level of the message, the number and/or the identities of other recipients of the message.

7. A computer program to be installed in a communication terminal for controlling the display of text messages during an execution of the program by a processing unit of the terminal, the program comprising:
at least one display module whose execution controls animated rendering of a text message with a predefined animation;
instructions for examining, in relation to characteristics of a text message to be displayed, at least one display module selection criterion recorded in the communication terminal in association with a display module so as to select a display module when a display module selection criterion associated with said display module is fulfilled by the analyzed characteristics and to execute the display module selected for said text message.

8. The computer program as claimed in claim 7, furthermore comprising a module for downloading display modules from at least one server for the installation of new display modules.

9. A display modules server for the execution of a method as claimed in claim 2, comprising a network interface for access from user terminals, and a set of display modules downloadable from the user terminals, in which the execution of each display module controls animated rendering of a text message with a predefined animation.

10. The computer program of one of claims 7 and 8, wherein the program is installed in the communication terminal by downloading.
